(19) United States
(12) Patent Application Publication
(10) Pub. No.: US 2014/0253788 A1
(43) Pub. Date: Sep. 11, 2014

(54) IMAGING DEVICE, MOTOR DRIVING DEVICE AND IMAGING METHOD

(71) Applicant: Hitachi, Ltd., Tokyo (JP)

(72) Inventors: Hiroki Saito, Tokyo (JP); Tomoaki Nishiguchi, Tokyo (JP); Toshiyuki Yokoyama, Yokohama (JP); Hideharu Ono, Tokyo (JP)

(73) Assignee: Hitachi, Ltd., Tokyo (JP)

(21) Appl. No.: 14/177,207

(22) Filed: Feb. 10, 2014

(30) Foreign Application Priority Data
Mar. 5, 2013 (JP) 2013-042505

(51) Int. Cl. H02P 8/38; H04N 5/232

(52) U.S. Cl. CPC H02P 8/38; H04N 5/23296
USPC 348/357; 318/696

(57) ABSTRACT

In an imaging device having a driving device using a stepping motor, improvement in recovery speed after a step out of the motor is realized. An imaging device having a driving device which carries out lens driving, diaphragm driving or pan-tilt-zoom driving with a stepping motor, includes: a motor driving unit which controls a current or voltage supplied to an exciting coil of the stepping motor; a system control unit which outputs a motor driving stop instruction to the motor driving unit; and a detection unit which detects a current or voltage flowing through the exciting coil after the stop instruction is outputted. The system control unit finds a direction of correction and an amount of correction to recover from a movement of a rotor due to a step out of the stepping motor, based on the current or voltage detected by the detection unit, and moves the stepping motor based on the direction of correction and the amount of correction.

### BACKGROUND OF THE INVENTION

1. Field of the Invention

The present invention relates to an imaging device, motor driving device, and an imaging method.

2. Description of the Related Art

A motor can continue rotating since the rotational speed of a rotating magnetic field generated between a stator and a rotor and the actual rotational speed of the rotor are kept equal to each other (hereinafter referred to as “synchronization state”). However, it is known that an overload on the motor or a sudden change in the speed of the rotor causes the rotational speed of the rotating magnetic field and the actual rotational speed of the rotor to shift from each other, deviating from the synchronization state. Also, a phenomenon that the rotor is moved by an external force or the like after a stop instruction to the rotor is issued may take place (hereinafter this phenomenon is referred to as “step out”).

A stepping motor as a type of motor, which is also called a pulse motor, can rotate on a predetermined step basis by being supplied with a pulse current.

FIG. 9 shows a pulse current supplied in each phase of the stator of a stepping motor in time series. FIG. 10 shows a stator 1001, a rotor 1002, and the positional relation between the stator (stator in black) in which the pulse current in time slots 1 to 4 of the pulse signal shown in FIG. 9 flows and the rotor.

FIG. 9 shows a half-step pulse current pattern in time series, as a way of supplying a pulse signal to the stepping motor. The numbers indicating time slots show the lapse of time. As can be seen from FIG. 9, for example, in the time slot 1, the pulse current is made to flow only through a phase A. In the time slot 2, the pulse current is made to flow through phases A and B. In the time slot 3, the pulse current is made to flow only through the phase B. Thus, a magnetic field is generated in the phase where the current flows.

In FIG. 10, it can be seen that, for example, in the time slot 1, the rotor is drawn into the A-A′ direction of the stator and stopped there by the field magnet due to the phase A. Similarly, in the other time slots, the rotor is drawn and stopped by the field magnet, of the stator. This enables rotation on a predetermined step basis.

The background art in this technical field is disclosed in JP-A-2006-129598. This literature discloses that “in a driving device using a stepping motor, an initialization operation is carried out for a driving mechanism and a stepping motor that are set in a phase relation where a phase that is electrified at the time of electrifying an exciting coil of the stepping motor at a stopper position that regulates an operation range of the stepping motor substantially meets a condition of single-phase electrification, and in a step out detection method for the stepping motor, whether to execute the initialization operation or not is decided after whether there is a step out state of the stepping motor or not is discriminated by a detection circuit for a counter electromotive voltage generated from the exciting coil in a non-electrified state of the stepping motor when the exciting coil is electrified in a next single-phase electrified state in the same direction from the stopper position that regulates the operation range of the driving mechanism of the stepping motor, a discrimination circuit which discriminates whether the generation time of the counter electromotive voltage exceeds a predetermined time or not, and a control circuit which controls those circuits.”

A stepping motor is characterized in that the position where the motor stops can be decided without using a sensor, since the rotational speed can be controlled by the speed of an excitation switching pulse of an electromagnet while the rotational angle can be controlled by the cumulative number of pulses. However, because of this characteristic, the stepping motor is usually not provided with a feedback circuit. Therefore, if a step out occurs in the stepping motor, it is difficult to restore the synchronization state.

As a technique for preventing such a step out of the motor, a holding current is made to flow continuously in the motor, thus maintaining the stop position of the rotor. The holding current has a small value compared with the case where the motor is driven. However, in the case where the motor and the motor driving device are installed in a small-sized product such as an imaging device, power consumption and heat generation due to the continuous flow of the current are seen as problems.

Also, in the technique disclosed in JP-A-2006-129598, though the step out due to the counter electromotive voltage generated in the exciting coil is detected, the lens needs to be positioned again to return to the lens stop position of the time before the step out in order to carry out initialization of the lens position. Therefore, it takes time to return to the lens stop position of the time before the step out of the motor.

### SUMMARY OF THE INVENTION

In view of the foregoing problems, it is an object of the present invention to move a motor to recover from a movement due to a step out when the motor has stepped out.

According to an aspect of the invention, an imaging device having a driving device which carries out lens driving, diaphragm driving or pan-tilt-zoom driving with a stepping motor, includes: a motor driving unit which controls a current or voltage supplied to an exciting coil of the stepping motor; a system control unit which outputs a motor driving stop instruction to the motor driving unit; and a detection unit which detects a current or voltage flowing through the exciting coil after the stop instruction is outputted. The system control unit finds a direction of correction and an amount of correction to recover from a movement of a rotor due to a step out of the stepping motor, based on the current or voltage detected by the detection unit, and moves the stepping motor based on the direction of correction and the amount of correction.

According to the above aspect of the invention, when the motor has stepped out, the motor can be moved to recover from a movement due to the step out of the motor.

### BRIEF DESCRIPTION OF THE DRAWINGS

FIG. 1 shows the configuration of a motor driving device according to an embodiment.

FIG. 2 is a flowchart of determination of step out of a stepping motor according to an embodiment.

FIGS. 3A and 3B show a motor step out current that is detected at the time of motor step out generated after a current to an exciting coil is stopped after a motor driving stop instruction is outputted, according to an embodiment.

FIGS. 4A and 4B show a motor step out current that is detected at the time of motor step out after a motor driving stop instruction is outputted, according to an embodiment.

FIGS. 5A and 5B show a motor step out voltage that is detected at the time of motor step out after a motor driving stop instruction is outputted, according to an embodiment.

FIG. 6 is a flowchart for explaining step out shift correction according to an embodiment.

FIG. 7 shows the structure of a lens driving unit that is generally used in an imaging device.

FIG. 8 shows a configuration involved in a lens driving system, including a lens, a motor that drives the lens, and the like.

FIG. 9 shows a half-step pulse current pattern in time series, as a way of supplying a pulse signal of a stepping motor.

FIG. 10 shows the positional relation between a stator through which a pulse current flows in a time slot of a pulse signal, and a rotor.

### DESCRIPTION OF THE PREFERRED EMBODIMENTS

### Embodiment 1

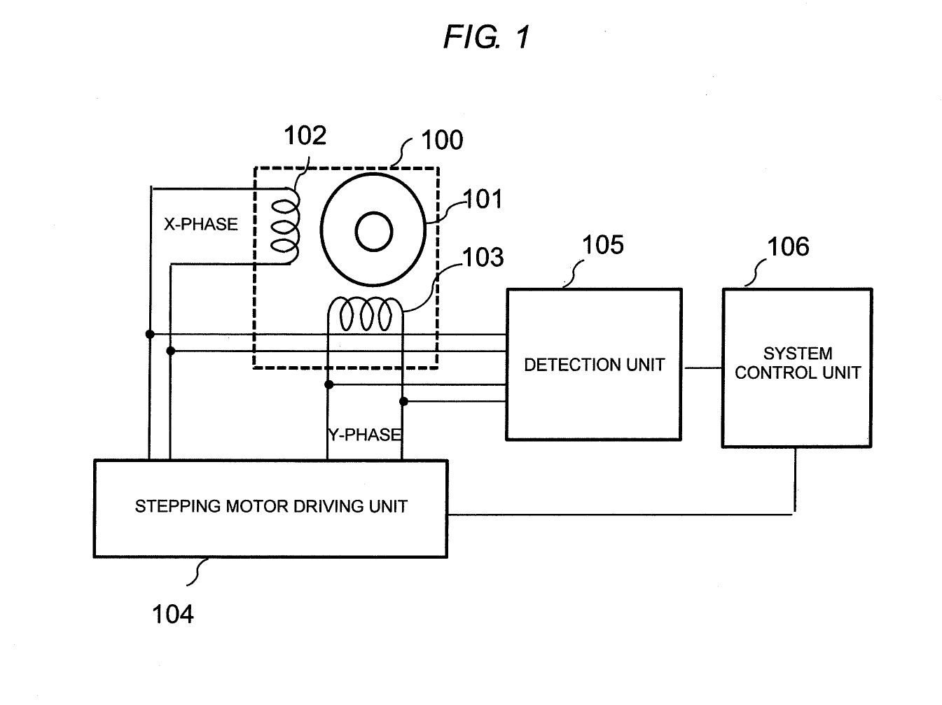

A mode for carrying out the invention (hereinafter referred to as “embodiment”) will be described with reference to FIGS. 1 to 8.

First, step out detection of a stepping motor in this embodiment will be described with reference to FIGS. 1 to 5B.

FIG. 1 shows the configuration of a motor driving device according to this embodiment.

A lens control device according to this embodiment has a stepping motor driving unit 104 which controls a stepping motor 100, a detection unit 105 which detects a current flowing through exciting coils 102, 103, and a system control unit 106 having the function of determining whether the stepping motor 100 has stepped out or not.

The stepping motor 100 has a single-phase model formed by a rotor 101 and the exciting coils 102, 103 through which a current/voltage for driving the stepping motor flows. In this embodiment, the respective exciting coils 102, 103 are assumed to be X-phase and Y-phase, respectively. The excitation system for the stepping motor used in this embodiment is not particularly limited and any of half-step, single-phase excitation, two-phase excitation, micro-step and the like. Also, while FIG. 1 shows an example where the stator is formed by the exciting coils, the rotor may be formed by an exciting coil.

The system control unit 106 outputs a control signal to control the motor. Specifically, a control signal such as a lens driving stop instruction in adjustment of the focusing position of the lens or decision of the focusing position of the lens is outputted. The system control unit 106 is connected to the stepping motor driving unit 104. The stepping motor driving unit 104 controls the current/voltage flowing through the exciting coils 102, 103, based on the control signal outputted from the system control unit 106, and thus controls the rotational speed and rotational angle of the stepping motor.

By the way, if an overload is applied to the motor by an external force or the like after the current/voltage to the exciting coils 102, 103 is stopped, a motion step out occurs in the rotor 101. In such a case, a current/voltage is generated in the exciting coils 102, 103 by a change in the magnetic field due to the rotation of the rotor 101. The current/voltage generated in this manner is detected by the detection unit 105. The result of the detection is outputted to the system control unit 106 connected to the detection unit 105. The system control unit 106 determines that the stepping motor has stepped out, based on the result of the current detection.

The system control unit 106 calculates the direction of shift and the amount of shift from a motor stop position, based on the result of the current/voltage detection, as described later. The system control unit 106 also outputs an instruction to carry out position correction to the stepping motor driving unit 104, based on the direction of shift and the like that is calculated.

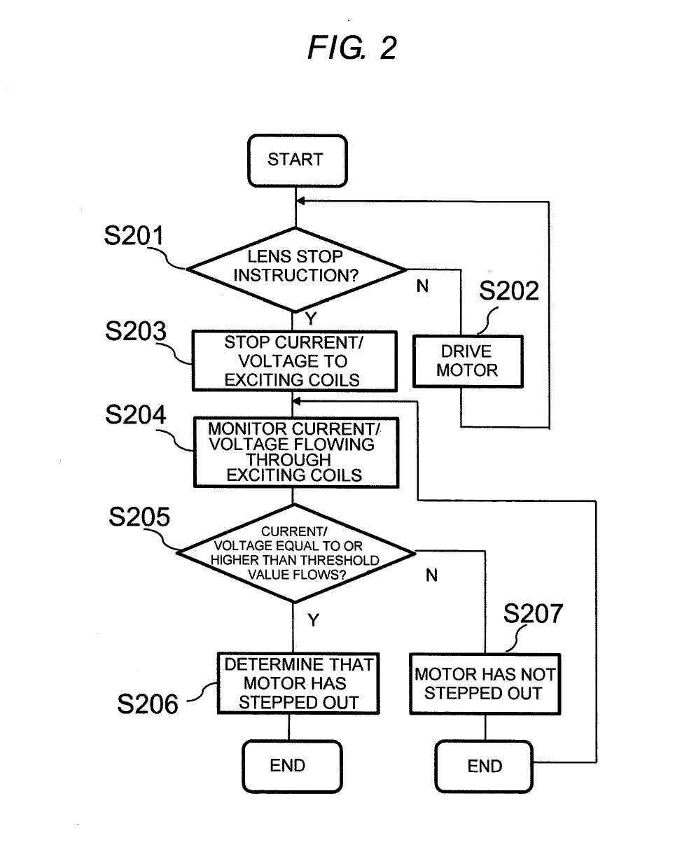

FIG. 2 is a flowchart of determination of step out of the stepping motor according to the embodiment.

First, it is determined whether a lens driving stop instruction is outputted to the stepping motor driving unit 104 from the system control unit 106 or not (S201).

If it is determined in S201 that a lens driving stop instruction is not outputted (S201, N), lens driving is continued (S202) and the processing returns to the beginning of the flow.

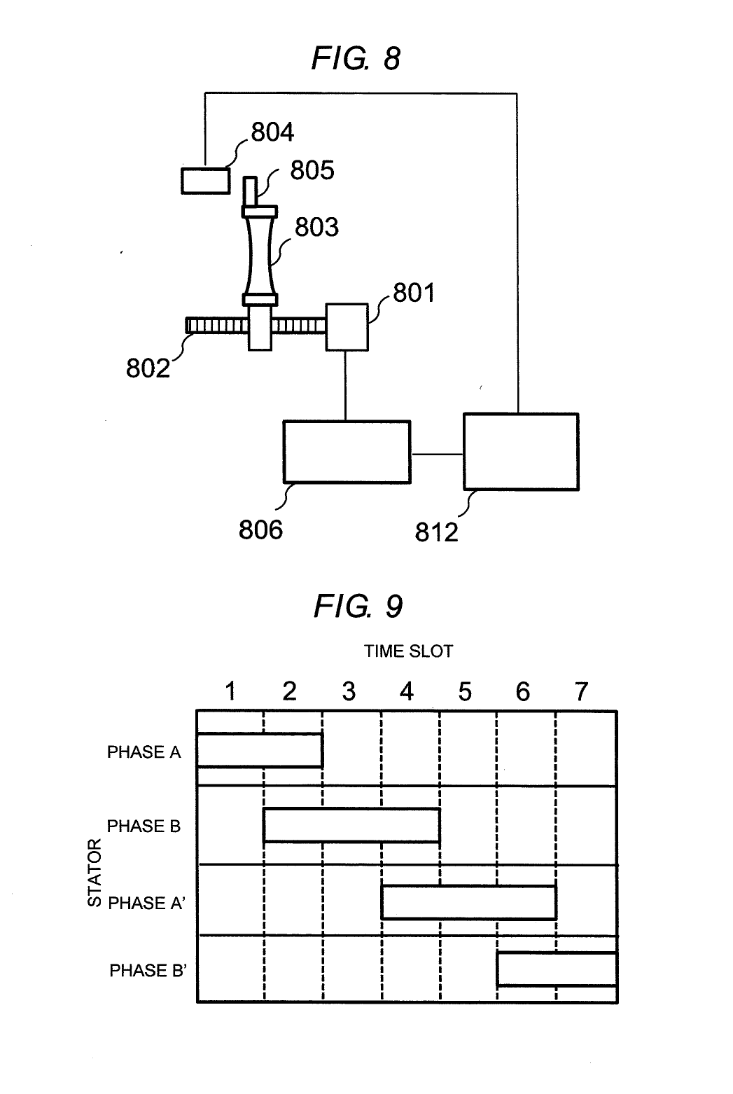

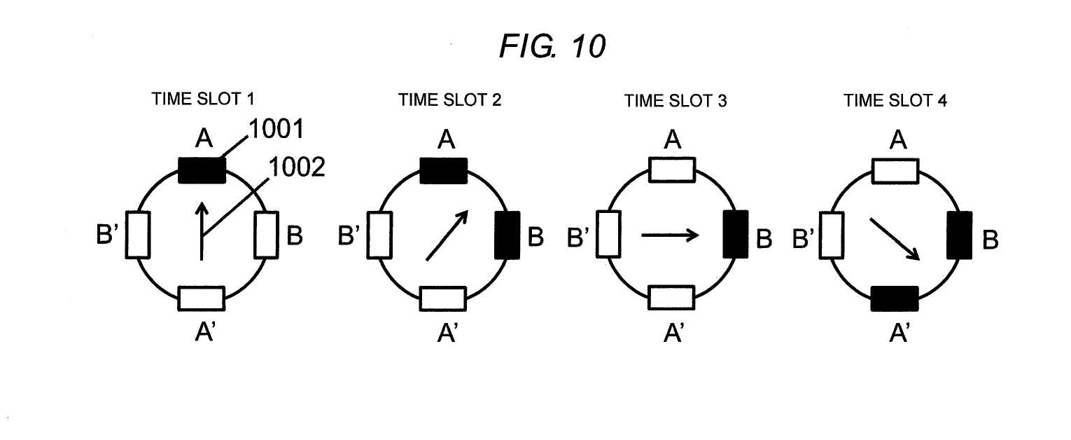

Meanwhile, if it is determined in S201 that a stop instruction is outputted (S201, Y), the current/voltage flowing to the exciting coils 102, 103 of the stepping motor from the motor driving unit 104 is stopped based on the output from the system control unit 106 (S203). By thus stopping the current/voltage to the exciting coils, it becomes easier to detect a step out current/voltage that is determined in a subsequent step, and it becomes possible to realize power-saving. However, step out detection and step out correction are possible even when the current/voltage is not stopped, as shown in FIGS. 8 and 9, which will be described later.

Next, the system control unit 106 monitors whether a current/voltage is detected in the exciting coils by the detection unit 105 or not (S204). If a current/voltage is detected in the exciting coils, the system control unit 106 determines whether the monitored current/voltage value exceeds a predetermined threshold value or not (S205). If it is determined that the monitored current/voltage value exceeds the predetermined threshold value, the system control unit 106 determines that the motor has stepped out (S206). The threshold value may be changed according to the system to be used. If it is determined in S205 that a current/voltage to the exciting coils is not detected by the detection unit 105, the system control unit 106 determines that the motor has not stepped out (S207). In a non-electrified state, current-based detection of a step out is advantageous in that a step out can be detected more easily than in voltage-based detection.

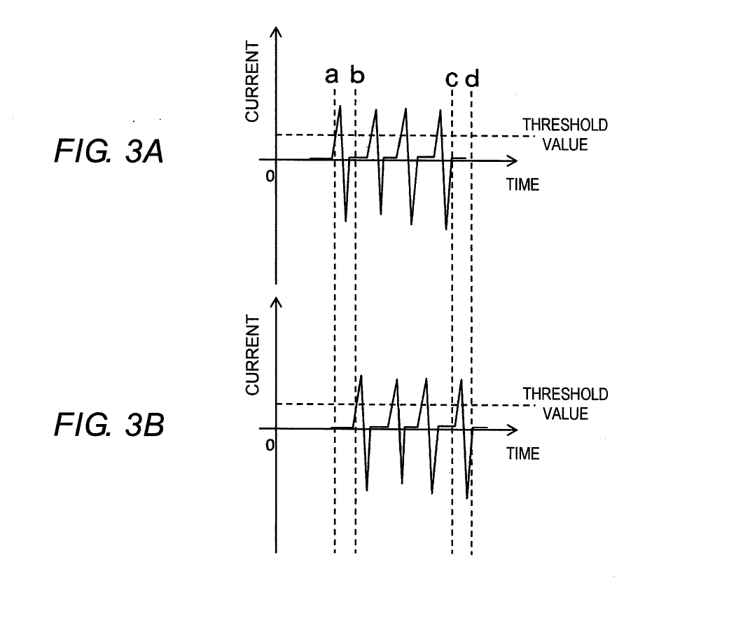

Now, a motor step out current or motor step out voltage detected in motor step out that occurs after a motor driving stop instruction is outputted will be described with reference to FIGS. 3A and 3B, FIGS. 4A and 4B, and FIGS. 5A and 5B.

FIGS. 3A and 3B show a motor step out current detected in motor step out that occurs after a current to the exciting coils is stopped after a motor driving stop instruction is outputted, according to this embodiment. FIG. 3A shows a step out current in a winding X of the exciting coils. FIG. 3B shows a step out current in a winding Y of the exciting coils. When a step out occurs, a counter electromotive force is generated in the exciting coils by a change in the magnetic field due to the rotation of the rotor. Therefore, step out currents as shown in FIGS. 3A and 3B flow. In FIG. 3A, the step out current due to the step out starts flowing at a time point a and the step out current due to the step out ends at a time point c. In FIG. 3B, the current due to the step out starts flowing through each exciting coil at a time point b and the step out current due to the step out ends at a time point d.

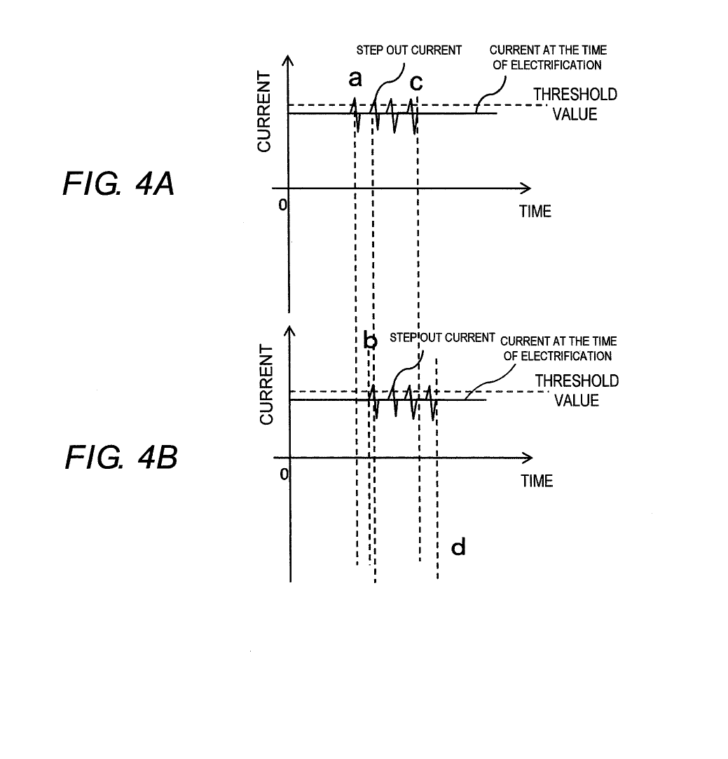

FIGS. 4A and 4B show a motor step out current detected in motor step out that occurs after a motor driving stop instruction is outputted, according to this embodiment. Similarly to FIGS. 3A and 3B, FIG. 4A shows a step out current in a winding X of the exciting coils and FIG. 4B shows a step out current in a winding X of the exciting coils. Unlike FIGS. 3A and 3B, FIGS. 4A and 4B show the step out current in the case where the step out occurs if a current such as a holding current flows through the exciting coils even after the motor driving stop instruction is outputted. Since a voltage such as a holding voltage flows through the exciting coils even after the motor driving stop instruction is outputted, similar behavior to FIGS. 3A and 3B is shown except that there is a current at the time of electrification, and therefore this will not be described further in detail.

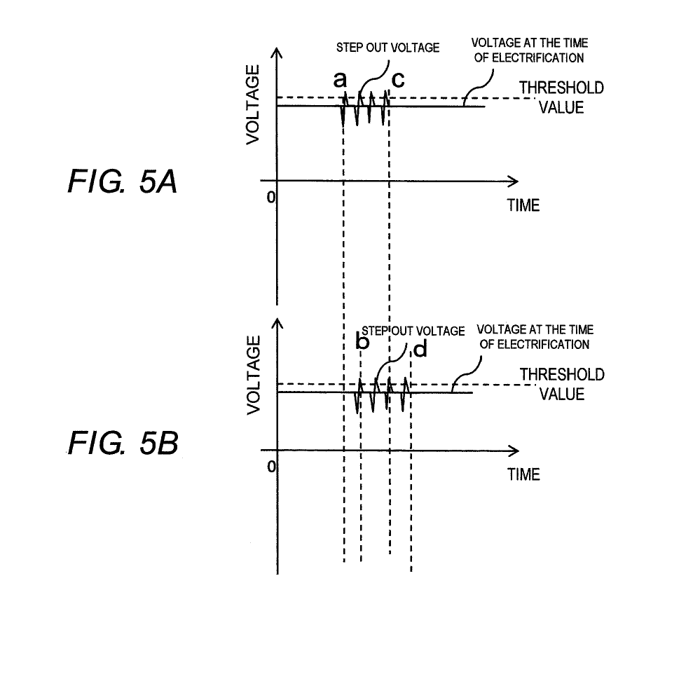

FIGS. 5A and 5B shows a motor step out voltage detected in motor step out after a motor driving stop instruction is outputted, according to this embodiment. FIG. 5A shows a step out voltage in a winding X of the exciting coils. FIG. 5B shows a step out voltage in a winding Y of the exciting coils. Similar behavior to FIGS. 4A and 4B is shown and therefore this will not be described further in detail.

The motor is driven with a constant voltage or constant current. However, the determination of motor step out in this embodiment is carried out based on the motor step out current in the case of a constant voltage, and based on the motor step out voltage in the case of a constant current.

By thus carrying out the determination of motor step out in S205 based on the current/voltage in the exciting coils generated in the case where the lens stop position is shifted, it is possible to determine whether there is a step out of the motor 101 or not, in a short period of time. Also, by employing the configuration in which the holding current is stopped after the motor is stopped, it is possible to carry out the determination of motor step out while realizing power saving.

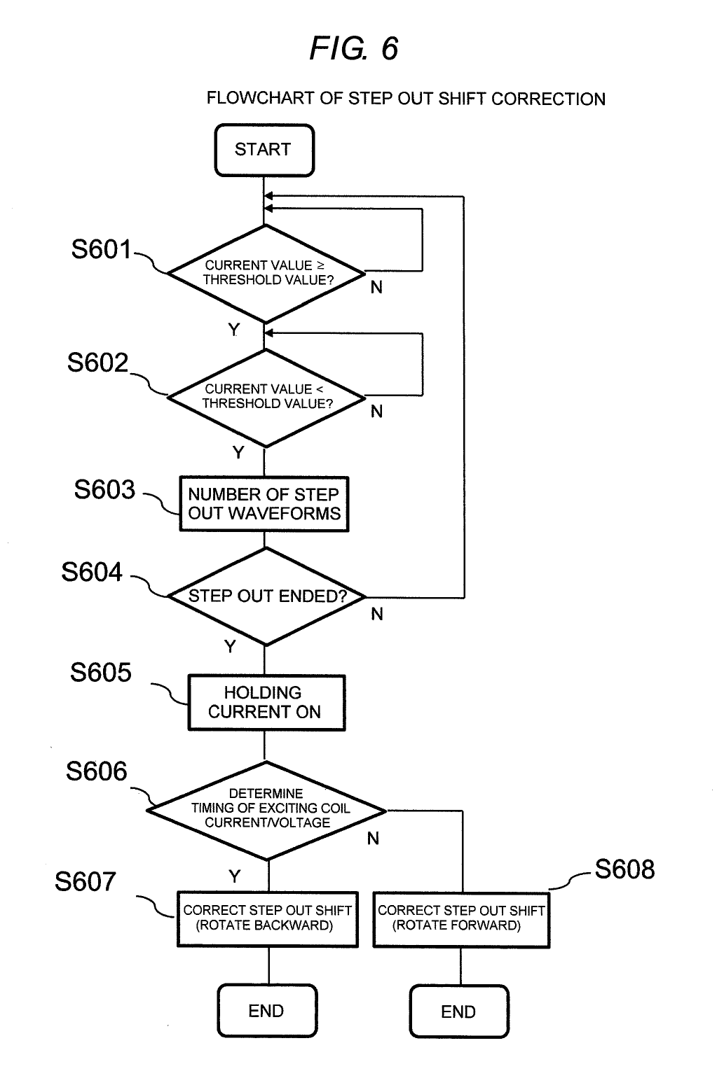

Next, an operation to return to the stop position based on the amount of shift from the lens stop position when the motor has stepped out will be described with reference to FIGS. 3A, 3B and 6.

First, a method for determining the direction of shift of the lens position based on the motor step out current will be described.

The motor can change its direction of rotation by the direction of the current flowing through the exciting coils. For example, in the motor 100 of FIG. 1, if a pulse current is made to flow through the exciting coils in order of X→Y, the motor moves in the direction of forward rotation. Meanwhile, if a pulse current is made to flow through the exciting coils in order of Y→X, the motor moves in the direction of backward rotation. That is, the direction of rotation of the motor can be controlled, based on the timing of the current flowing through the exciting coils. Therefore, after a motor driving stop instruction, the current or voltage flowing through each of the plural exciting coils can be detected, and the direction of the step out of the motor can be determined based on the timing when the current or voltage is detected in each exciting coil. For example, if there is a first exciting coil in which a current or voltage is detected at an early timing and a second exciting coil in which a current or voltage is detected at a later timing than in the first exciting coil, it can be understood that a step out has occurred in a direction in which the rotor rotates from the second exciting coil to the first exciting coil.

FIGS. 3A and 3B show a motor step out current detected in motor step out that occurs after a current to the exciting coils is stopped after a motor driving stop instruction is outputted, according to this embodiment, as described above. In FIGS. 3A and 3B, since the threshold is exceeded in the exciting coil X earlier than in the exciting coil Y, it can be understood that the current flows through the exciting coils in order of X→Y and that the step out rotates in the direction of forward rotation. Here, the case where the exciting coils have one phase is described. However, the direction of step out can be determined as described above, regardless of the number of phases of the exciting coils.

Next, calculation of a shift of the lens position will be described, based on the motor step out current.

When the motor steps out, the waveform frequency as shown in FIGS. 3A and 3B is generated, as described above. However, since the rotational angle corresponding to one waveform of the motor is decided univocally for each motor, it can be understood that the motor is shifted by the amount corresponding to the number of waveforms obtained after the occurrence of the step out.

Hereinafter, a method for moving the motor based on the direction of step out and the step out shift will be described with reference to FIG. 6.

FIG. 6 is a flowchart for explaining step out shift correction according to this embodiment. Here, a flowchart in the circumstance where the holding current is stopped after a motor stop instruction is outputted will be described.

First, the detection unit 105 determines whether the current flowing when the motor steps out exceeds a threshold value or not (S601). If the current/voltage value exceeds the threshold value (S601, Y), the processing goes to S602. If the current/voltage value does not exceed the threshold value (S601, N), the observation and determination continues until the observed current/voltage exceeds a first threshold value.

If the observed current/voltage exceeds the threshold value (S601, Y), it is determined whether the observed current/voltage falls below the threshold value after exceeding the threshold value (S602). If the observed current/voltage does not fall below the threshold value (S602, N), the observation and determination continues until the observed current/voltage falls below the threshold value. If the observed current/voltage falls below the threshold value (S602, Y), the system control unit 106 counts the number of waveforms of the step out current/voltage (S603). Since such a determination is carried out, the number of waveforms of the step out current/voltage can be properly counted even if the observed current/voltage shifts with reference to the threshold value as maximum value.

Next, the detection unit 105 detects whether the observed current/voltage has become zero or the current at the time of electrification. Thus, the system control unit 106 determines whether the step out of the motor has ended (S604). If it is determined that the step out has not ended (S604, N), the processing is executed again from S601. Meanwhile, if it is determined that the step out has ended, a holding current/voltage is supplied to the motor from the stepping motor driving unit 104 so that no further step out takes place (S605). Here, the processing of the subsequent steps may be carried out while the holding current/voltage is left stopped, giving priority to power-saving. However, considering that the motor can step out further after the determination of the previous step out, it is desirable to apply a holding current to the motor in order to properly correct the step out shift.

Next, in order to determine the direction of position shift of the motor due to the step out, the system control unit 106 determines the timing of the exciting coil current in S606. If the motor has stepped out by rotating forward as can be seen from the result of the determination of the current timing, it corresponds to Y in S606 and therefore the processing goes to S607. Since the current/voltage flows from X to Y, it can be understood that the motor has stepped out by rotating forward. Meanwhile, if the motor has stepped out by rotating backward, it corresponds to N in S606 and therefore the processing goes to S608.

In S607, the step out shift is corrected via current/voltage control by the stepping motor driving unit 104, based on the direction of step out shift correction determined in S606 and the number of waveforms determined in S603. In S607, since it is known in S606 that the motor has stepped out by rotating forward, it can be understood that the direction of step out shift correction is backward. That is by causing a current or voltage for rotating the motor backward to flow through the exciting coils and supplying a pulse current having the number of waveforms to the motor, the motor can be moved to recover from the movement due to the step out. S608 is similar and therefore will not be described further in detail. Considering that the stepping motor rotates by a rotational angle corresponding to the number of drive pulses, the amount of step out shift can be calculated based on the product of the number of step out waveforms and the rotational angle of a unit waveform defined for each motor, and the motor can be moved by this amount of shift, thus correcting the step out shift.

Using this flow, for example, in the case of motor step out as shown in FIGS. 5A and 5B, since the current flows in order of X→Y (the motor rotates forward) and the number of waveform cycles is 4, a pulse current may be made to flow in order of Y→X in 4 waveform cycles in order to correct the motor step out. Thus, the movement of the motor due to the step out can be corrected.

In the flow of FIG. 6, the detection of the step out waveform frequency (S603) and the determination of the direction of step out shift (S606) may be carried out simultaneously, or the detection of the step out waveform frequency may be carried out after the determination of the direction of step out shift is carried out.

As described above, in the embodiment, when the motor has stepped out, the direction of step out shift correction and the amount of correction can be found based on the detected current or voltage without using a position sensor or the like, and the step out shift of the motor can be corrected.

### Embodiment 2

In this embodiment, an example where the motor driving device described in Embodiment 1 is installed in an imaging device will be described. A stepping motor is capable of fine movement of step-wise rotation and therefore often used for focus positioning or the like of a lens in the imaging device.

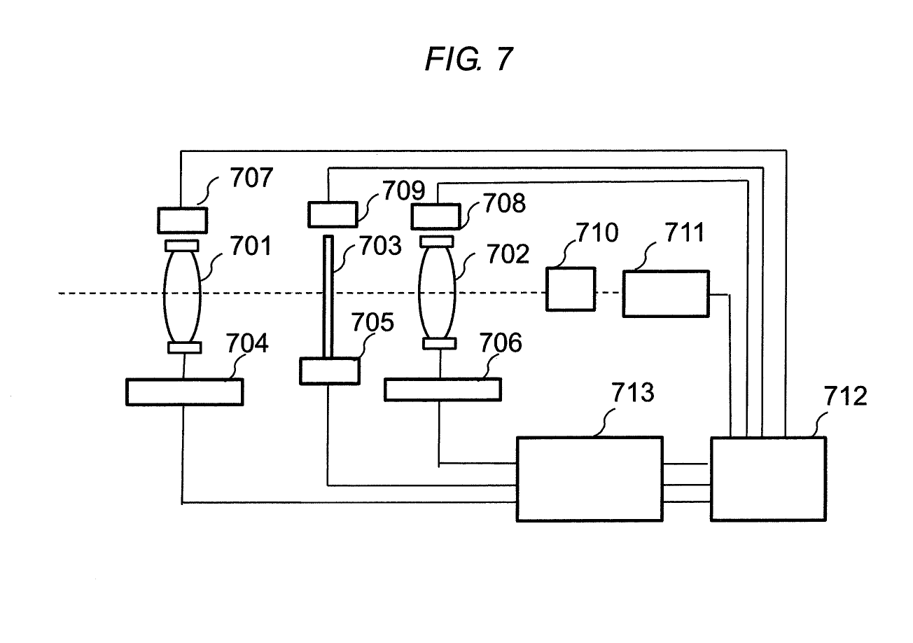

FIG. 7 shows the structure of a lens driving unit that is generally used in the imaging device.

The lens driving unit includes at least a zoom lens 701, a focusing lens 702, a diaphragm 703, motor driving units 704 to 706, position encoders 707 to 709, an imaging element 710, an A/D conversion unit 711, a system control unit 712, and a detection unit 713.

In order from the object side, the zoom lens 701, the diaphragm 703 and the focusing lens 702 are arranged. These components are mechanically connected to motors, not shown. As the motors are driven, these components are guided in the direction of optical axis via a guide shaft, not shown. The motors connected to the zoom lens 701, the diaphragm 703 and the focusing lens 702 are connected to the driving units 704, 705 and 706, respectively, and are controlled by receiving input of a drive signal from the driving units.

The positions of the zoom lens 701, the focusing lens 702 and the diaphragm 703 are detected by the position encoders 707, 708 and 709, respectively. As the position encoders, for example, photo-interrupters are used.

The motor driving units 704 to 706, the system control unit 712 and the detection unit 713 have similar functions to the motor driving unit 104, the system control unit 106 and the detection unit 105, respectively, described in Embodiment 1, and therefore will not be described further in detail.

FIG. 8 shows a configuration involved in a lens driving system including a lens, a motor which drives the lens, and the like. The lens driving system includes a motor 801, an output shaft 802, an optical system lens 803, a position encoder 804, a light-shielding member 805, a motor driving unit 806, and a system control unit 812.

The output shaft 802 is connected to the motor 801 and is made to rotate by the rotational motion of the motor. A feed screw is formed on the output shaft 802. As the output shaft is made to rotate by the rotational driving of the motor 801, the position of the lens 803 can be adjusted. As described above, a stepping motor is often used as the motor 801 used to move the lens.

Back to FIG. 7, the imaging element 710 receives incident light from an object via the zoom lens 701, the diaphragm 703 and the focusing lens 702, then converts the incident light into an electrical signal by photoelectric conversion, and outputs the resulting imaging signal to the A/D conversion unit 711.

The A/D conversion unit 711 converts the imaging signal from the imaging element 710, which is an analog signal, into a digital signal.

The system control unit 712 controls the imaging element 710, the A/D conversion unit 711, focusing and magnification in lens control, and, the position encoders.

In the imaging device in which the lens is driven by motor driving, for example, an external force to the lens or the weight of the lens itself may cause the motor to step out.

Particularly in the case where the imaging device is used for surveillance, the imaging device is often placed in an external environment where vibration due to traveling automobiles and an external force tend to act on the device, and therefore a step out tends to occur. Since the occurrence of a step out may cause a circumstance where an important image cannot be picked up, the lens position needs to be adjusted quickly even if a step out occurs. However, conventionally, if a step out occurs after focus positioning of the lens is finished and the lens is stopped, readjustment can only be made by initializing the lens position or the like and it takes time to readjust the lens position.

Also, the imaging device for surveillance rarely carries out constant auto-focusing based on video signals. Once the lens position is decided by auto-focusing, often, a manual focusing is switched on and the lens position remains fixed. If a lens position shift occurs due to an external force or the like in this case, it is difficult to correct the lens position shift quickly. According to the embodiment, even if the motor has stepped out, the step out of the motor is detected and the motor is moved by the amount of the step out shift without having to readjust the lens position. Thus, the lens can be returned to the state before the step out. Therefore, a convenient imaging device which requires a shorter time for focusing due to a step out can be realized.

Also, since the determination and correction of a step out is carried out after the holding current is stopped after lens focus positioning, power consumption and heat generated due to continuous flow of current can be prevented in an imaging device in a small-sized product where power consumption and heat generation due to continuous flow of current are seen as a problem.

Moreover, the embodiment can be applied not only to lens position shift but also to diaphragm position shift and to a motor used when carrying out pan-tilt-zoom in the casing of the imaging device. Even if the motor steps out due to an external force or the like after the direction of imaging and zooming are decided, the time for restoring the state of pan-tilt-zoom before the step out can be reduced.

The invention is not limited to the above embodiments and includes various modifications. The above configurations, functions, processing units, processing measures and the like may be realized partly or entirely by hardware, for example, designed on an integrated circuit. The above configurations, functions and the like may also be realized by software as a processor interprets and executes a program that realizes each function. Information of the program, table, file and the like to realize each function can be stored in a recording device such as a memory, hard disk, or SDD (solid state drive), or in a recording medium such as an IC card, SD card, or DVD.

What is claimed is:

1. An imaging device having a driving device which carries out lens driving, diaphragm driving or pan-tilt-zoom driving with a stepping motor, the imaging device comprising:
a motor driving unit which controls a current or voltage supplied to an exciting coil of the stepping motor;
a system control unit which outputs a motor driving stop instruction to the motor driving unit; and
a detection unit which detects a current or voltage flowing through the exciting coil after the stop instruction is outputted;
wherein the system control unit finds a direction of correction and an amount of correction to recover from a movement of a rotor due to a step out of the stepping motor, based on the current or voltage detected by the detection unit, and moves the stepping motor based on the direction of correction and the amount of correction.

2. The imaging device according to claim 1, wherein
the system control unit finds determines a direction of step out of the stepping motor based on detection timing of the current or voltage and also finds a number of waveforms of the current or voltage, and
the motor driving unit moves the rotor of the stepping motor to recover from the movement due to the step out of the stepping motor, based on the direction of step out and the number of waveforms.

3. The imaging device according to claim 2, wherein a current or voltage with the number of waveforms that moves the motor in a direction opposite to the direction of step out is supplied to the stepping motor.

4. The imaging device according to claim 1, wherein if a stop instruction of the lens driving is outputted from the system control unit, a direction of step out and a number of waveforms are calculated after the current flowing through the exciting coil is stopped.

5. The imaging device according to claim 1, wherein a holding current is made to flow through the stepping motor after detection of the current or voltage by the detection unit ends.

6. The imaging device according to claim 1, wherein an amount of shift due to the step out is found based on the number of waveforms, and the rotor of the stepping motor is moved based on the amount of shift.

7. The imaging device according to claim 1, wherein, of each exciting coil where the current or voltage is detected, a first exciting coil with an earlier timing and a second exciting coil with a later timing than the first exciting coil are decided, and it is determined that the stepping motor rotates and steps out in a direction of rotation toward the second exciting coil from the first exciting coil.

8. A motor driving device which drives a stepping motor, comprising:
a motor driving unit which controls a current or voltage supplied to an exciting coil of the stepping motor;
a system control unit which outputs a motor driving stop instruction to the motor driving unit; and
a detection unit which detects a current or voltage flowing through the exciting coil after the stop instruction is outputted;
wherein the system control unit finds a direction of correction and an amount of correction to recover from a movement of a rotor due to a step out of the stepping motor, based on the current or voltage detected by the detection unit, and moves the stepping motor based on the direction of correction and the amount of correction.

9. An imaging method comprising:
outputting a motor driving stop instruction to a stepping motor driving unit which carries out lens driving, diaphragm driving or pan-tilt-zoom driving;
stopping a current or voltage flowing through an exciting coil if the motor driving stop instruction is outputted;
detecting the current or voltage in the exciting coil of the stepping motor after the stop instruction is outputted; and
finding a direction of correction and an amount of correction to recover from a movement of a rotor due to a step out of the stepping motor, based on the current or the voltage.
